(19) United States
(12) Patent Application Publication
(10) Pub. No.: US 2022/0258505 A1
(43) Pub. Date: Aug. 18, 2022

(54) VAPOR REMOVAL

(71) Applicant: Hewlett-Packard Development Company, L.P., Spring, TX (US)

(72) Inventors: Vito Di Virgilio, Sant Cugat del Valles (ES); Xavier Oliva Ventayol, Sant Cugat del Valles (ES); Lluis Abello Rosello, Sant Cugat del Valles (ES)

(21) Appl. No.: 17/639,787

(22) PCT Filed: Oct. 11, 2019
(86) PCT No.: PCT/US2019/055928

§ 371 Date: Mar. 2, 2022

(51) Int. Cl. B41J 29/377; B41J 3/407; B41J 3/36

(52) U.S. Cl. CPC B41J 29/377; B41J 3/36; B41J 3/4078

(57) ABSTRACT

An example apparatus is for printing to a substrate. The example apparatus comprises a printing fluid device and an air flow device. The printing fluid device is for transferring printing fluid to a substrate. The air flow device is to create an air curtain so that any printing fluid residue from the transfer of the printing fluid to the substrate is at least partially prevented from migrating toward a user of the apparatus.

### BACKGROUND

Some example printing systems are to print an image onto a substrate using a printing fluid.

### BRIEF DESCRIPTION OF DRAWINGS

Examples will now be described, by way of non-limiting example, with reference to the accompanying drawings, in which;

FIG. 1a is a simplified schematic of an example apparatus;

FIG. 1b is a simplified schematic of an example apparatus;

FIGS. 2a-2c are simplified schematics of an example airflow curtain being created by an example apparatus;

FIG. 3 is a flowchart of an example method;

FIG. 4 is a flowchart of an example method;

FIG. 5 is a simplified schematic of an example apparatus; and

FIG. 6 is a simplified schematic of an example apparatus.

### DETAILED DESCRIPTION

In some printing systems, an image is transferred to a substrate by hot pressing a substrate such as paper (having an image formed thereon) to another substrate, such as a garment, over a relatively long time period. The heat involved during such processes can cause the release of vapors but, due to the time involved, the quantity of vapors emitted may not be sufficient to disturb an operator. However, some printing systems that are able to achieve a quicker print to a substrate (such as a garment) may generate a higher quantity of vapors that can be detected by an operator of the apparatus. If the vapors have an unpleasant odour then this may be a source of discomfort to the operator of the apparatus.

Some examples herein relate to printing an image to a substrate. For example, an apparatus for printing to a substrate may direct printing fluid (which may comprise an ink) toward a substrate to form the image thereon. In these examples, the printing fluid may comprise printing fluid solids (for example a solid pigment, such as an ink pigment) suspended in a liquid printing fluid carrier. In these examples, particularly when the substrate comprises a textile fabric such as a garment, when the printing fluid is discharged and deposited onto the substrate the substrate may be subjected to heat in order to evaporate the liquid carrier from the printing fluid solid, leaving the printing fluid solid suspended in or on the substrate to form the image thereon. Sometimes, the process of applying heat to the printing fluid to evaporate the liquid carrier is referred to as “sublimation”, and the part of the printing apparatus at which this process occurs may be referred to as a sublimation station. During this “sublimation” process, the printing fluid effectively goes through a phase change during which it changes from a liquid (with solid particles suspense therein) to a gas, as the printing fluid solids are deposited onto the substrate and, the applied head may cause the liquid component in the printing fluid to at least partially evaporate. This may result in printing fluid residue (e.g. printing fluid vapor) being present in the apparatus. In other words, the printing apparatus may comprise a portion of printing fluid residue (or remnant, or vapor) following a “sublimation” process during which heat is applied to effectively evaporate the printing fluid.

Some examples herein relate to a printing apparatus that is to prevent printing fluid residue (e.g. vapors) from reaching a user of the apparatus. As mentioned above, heating the printing fluid residue may create vapor which may be emitted from the apparatus and/or may have an unpleasant odour, and therefore preventing the residue from reaching a user of the apparatus (e.g. their facial area) may enhance the experience of using the printing apparatus to print to a substrate, particularly when the printing apparatus comprises a hand-held apparatus (in which cases the user may be particularly close to the apparatus, e.g. holding it). In examples where the apparatus comprises a hand-held apparatus, the position of the apparatus relative to a user's face is likely to change as the user manipulates the apparatus to print to a substrate (e.g. by moving the apparatus across the surface of the substrate). Therefore, some examples herein relate to preventing printing fluid residue from migrating toward a user even when the apparatus is to be operated by a user while holding the apparatus.

To prevent printing fluid residue, such as vapor, from contacting the face of a user, (hereinafter used synonymously with the term “operator”), of the printing apparatus, some examples herein relate to creating a laminar flow of air, or an air curtain, to at least partially prevent printing fluid residue following transfer of printing fluid to the substrate, from travelling toward a user of the printing apparatus. In some examples, the laminar flow, or air curtain, is parallel to the substrate (e.g. across the substrate) and/or the sublimation station, but in other examples the laminar flow or air curtain may be otherwise oriented, as will be explained below. In some examples, the air curtain is to prevent any air on one side of the air curtain crossing the air curtain to the other side—for example preventing printing fluid residue or vapor on one side of the air curtain (the substrate side of the air curtain) from crossing the air curtain to the operator side of the air curtain. In some examples, the printing apparatus is to create an air curtain, or laminar flow, in between the substrate and an operator of the printing apparatus. In other examples, the printing apparatus is to create an air curtain, or laminar flow, in between the substrate and the printing apparatus. In some examples, the air curtain may therefore comprise an interface between two regions of different pressures and/or air flow rates which may prevent residue or vapor on one side of the air curtain crossing the air curtain. In some examples, the air curtain may be disposed between a print area of the printing apparatus (e.g. a region in which printing fluid is being deposited toward a substrate) and a user of the apparatus.

According to some examples, the printing apparatus may comprise an air flow device, which may comprise a blower and/or fan, to create the laminar flow or air curtain, e.g. using a plurality of blades to move the air.

According to some examples herein, the printing apparatus comprises a means to treat the printing fluid residue, or vapor, for example a treatment station. For example, the printing apparatus may comprise a demister and a filter, the demister being to remove any liquid present in the printing fluid residue, and the filter being to reduce the concentration (e.g. of volatile organic compounds, sometimes abbreviated to VOCs) in the printing fluid residue/remnant/vapor etc. In some examples, the laminar flow or air curtain created by the printing apparatus is to direct printing fluid residue, or vapor, to such a treatment station.

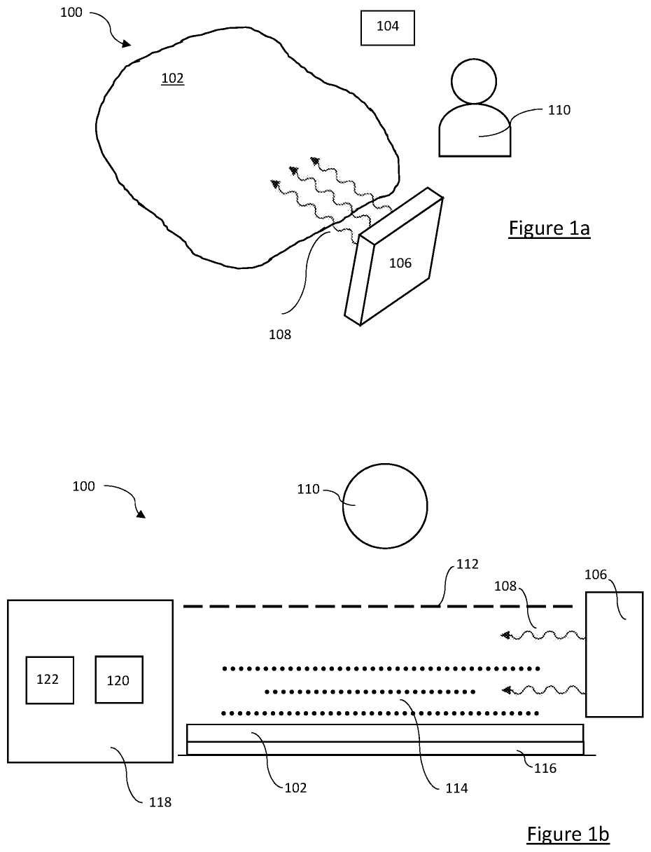

FIG. 1 shows an example apparatus 100 for printing to a substrate 102. The apparatus 100 comprises a printing fluid device 104 to transfer printing fluid to the substrate 102 (e.g. to print an image to the substrate 102, for example according to image generation data, or instructions, describing an image to be printed to the substrate). The apparatus 100 also comprises an air flow device 106 to create an air curtain (schematically indicated in FIG. 1a by the arrows 108 depicting a flow of air from the air flow device 106). The air flow device 106 is to create the air curtain such that any printing fluid residue from the transfer of printing fluid to the substrate 102 (e.g. during a printing process or operation) is at least partially prevented from migrating toward a user of the apparatus (schematically indicated by 110).

To create the air flow curtain, the air flow device 106 may therefore be to emit a flow of air 108. As shown in FIG. 1a the flow of air may be across the substrate 102, for example in a direction parallel to the substrate 102. The air flow device 106 may therefore be to create the air curtain such that the air curtain is parallel to the substrate. In one example, the air flow device 106 may be to create the air curtain such that the air curtain is in between the substrate and the operator and/or in between the substrate and the apparatus. The air flow curtain created by the air flow device 106 is shown in FIG. 1b.

FIG. 1b shows an example apparatus 100 which may comprise the example apparatus 100 shown in FIG. 1a. FIG. 1b shows the air flow device 106 creating a flow of air 108 across the substrate 102 such to create the air curtain—schematically shown by the dotted line 112. During the printing process (e.g. when the printing fluid device 104 (not shown in FIG. 1b) transfers printing fluid to the substrate 102 to print an image to the substrate, there may be printing fluid residue, as schematically shown at 114, which may comprise a printing fluid remnant following sublimation, for example a printing fluid vapor. The operator, or user, of the apparatus is schematically shown at 110 and the air curtain 112 is to prevent the printing fluid residue 114 from migrating toward the user 110. As FIG. 1b shows, the air flow device 106 is to create the air curtain 112 such that the printing fluid residue 114 is at least partially prevented from crossing the air curtain 112 (e.g. from the “substrate side” of the air curtain—the side having the substrate—to the “operator side” of the air curtain—the side of the air curtain with the operator). In other words, the air curtain 112 may define an interface, or boundary, between two regions of the apparatus, a substrate side and an operator side, and the air curtain 112 may be to prevent printing fluid residue crossing from the substrate side to the operator side. The air curtain 112 is created, as shown in FIG. 1b, in between the substrate 102 and the operator 110. In other examples, the air curtain 112 may be created in between the apparatus 100 and the substrate 102 (e.g., in examples where the apparatus 100 comprises a hand-held apparatus, to be discussed below).

As shown in FIG. 1b, the apparatus 100 may comprise a heating device 116 that may be to apply heat to the substrate 102 to sublimate the printing fluid deposited thereon. The heating device 116 may comprise a sublimation station. In some examples, the printing fluid residue 114 may be generated following the application of heat from the heating device 116 to the substrate to heat to the substrate 102 and thereby cause the evaporation of any liquid carrier from the printing fluid (as explained above). The apparatus 100 also comprises a treatment station 118. The treatment station 118 in this example is to treat the printing fluid residue 114 produced during a printing operation, for example for release into the environment or for storage in a reservoir after treatment. The treatment station 118 in this example comprises a demister 120 and a filter 122. The demister 120 in this example is to remove any liquid component of the printing fluid residue, for example to prevent condensation of the printing fluid residue 114 that enters the treatment station 118. For example, the liquid component of the printing fluid residue 114 may be “thicker” and “heavier” than water (for example the printing fluid residue may comprise a vapor pressure and density that is different from water, e.g. larger than the vapor pressure and density of water) and the demisting of the printing fluid residue 114 may prevent the residue from condensing inside the treatment station 118. Demisting may therefore cause the printing fluid residue 114 to be separated into a liquid component and a vapor component, with the liquid component remaining in the demister 120 (and later cleaned or collected). The vapor may contain VOCs and so the filter 120 of the treatment apparatus 118 may be to remove, or at least partially decrease, the concentration of VOCs in the resultant vapor. For example, the filter 120 may be to adsorb the VOCs in any vapor passing therethrough. In other examples, the filter 120 may comprise another kind of filter (passive or active).

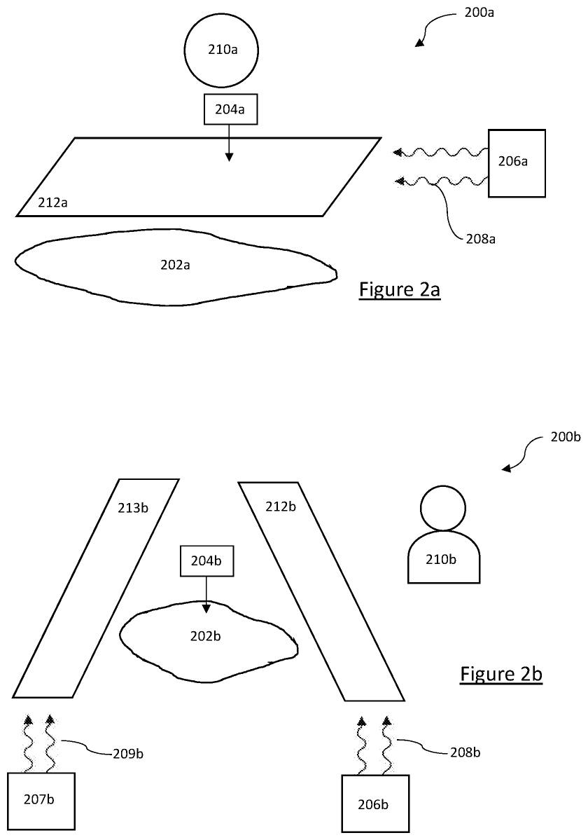

As discussed above with reference to the example apparatus 100 depicted in FIGS. 1a and 1 b, the air curtain 112 may be created by a flow 108 of air, which (as depicted in FIGS. 1a and 1b) may be across the substrate 102 and/or parallel to the substrate 102. However, in other examples the air curtain 112 may be created differently, or differently oriented, which will now be described with reference to the examples depicted in FIGS. 2b and 2c.

FIGS. 2a-2c show three example apparatus 200a-c, each of which has an air curtain. In each example, each apparatus 200a-c comprises a respective operator (schematically indicated by 210a-c, respectively), a substrate 202a-c, and an example printing fluid device 204a-c to transfer printing fluid to the respective substrates 202a-c (as schematically indicated by the arrow therefrom), Each apparatus 200a-c comprises a respective an air flow device 206a, 206b, 207b, and 206c, creates a respective air curtain 212a, 212b, 213b, 212c through the creation of a flow of air 208a, 208b, 209b, 208c.

FIG. 2a shows an example apparatus 202a in which an air curtain (indicated schematically by the plane 212a) is created across the substrate 202a and parallel to the substrate 202, and which may therefore comprise the apparatus 100 as shown in FIGS. 1a and 1 b. The air flow device 206a emits a flow of air 208a to create the air curtain which comprises an interface between, in this example, a region proximate the substrate of a first pressure and first air flow rate (and, in some examples, a first air speed and/or a first air temperature) and a region remote from the substrate (and comprising the operator 210a) of a second pressure and second air flow rate (and, in some examples, a second air speed and/or a second air temperature). The differences in pressures and air flow rates on either side of the interface at least partially prevents printing fluid residue from migrating across the air curtain, and therefore migrating toward the user 210a (as described with reference to FIG. 1b), As shown in FIG. 2a, the user 210a operating the apparatus 200 is positioned behind the printing fluid device 204a and, in this example, the air curtain 212a is created in between the printing fluid device 204a and the substrate 202a, and also in between the substrate 202a and the operator 210a.

FIG. 2b shows an example apparatus 200b comprising two air flow devices 206b, 207b, each of which is to create a respective air curtain 212b, 123b, by producing a respective flow of air 208b, 209b. In the example apparatus 202b shown in FIG. 2b, the operator 210b is shown positioned remote from the printing fluid device 204b but the air curtain 212b is nevertheless created to prevent printing fluid residue from migrating from a region proximate the substrate 202a and/or the printing fluid device 204b (regions which, as described above, may comprise printing fluid residue) toward the user 210b. The apparatus 202b comprises two air flow devices 206b, 207b and the air curtains 212b, 213b created by each device are shown at an angle to the substrate (e.g. not parallel to the substrate). In the apparatus 200b, a plurality of air flow devices 206b, 207b create a plurality of air curtains 212b, 213b, so as to at least partially prevent printing fluid residue from migrating toward a plurality of users of the apparatus, of a user and one other person. For example, the two air curtains 212b, 213b created by the example apparatus 200b will at least partially prevent printing fluid residue from migrating toward a person positioned to the right (with reference to the configuration shown in FIG. 2b) of the apparatus (e.g. user 210b as shown in FIG. 2b) and a person positioned to the left of the apparatus (with reference to the configuration shown in FIG. 2b). Although in this example a plurality of air flow devices are to create a plurality of air curtains, one each respectively, in other examples an air flow device may be to create a plurality of air curtains, or a plurality of air flow devices may be to create an air curtain.

Similarly, FIG. 2c shows an example apparatus 200c comprising an air flow device 206c that is to create an air curtain 212c by creating a flow of air 208c such that the air curtain 212c is substantially perpendicular to the substrate 202c. In this example, all persons positioned to the right of the apparatus 200c (with reference to the configuration shown in FIG. 2c) are effectively shielded from printing fluid residue resulting from the transfer of printing fluid to the substrate 202c. As for the example of FIG. 2a, the air curtains comprise an interface between a first region of the apparatus (having a first air flow rate and first pressure) and a second region of the apparatus comprising the operator 210a (having a second air flow rate and second pressure), and the differences in pressures and air flow rates on either side of the interface at least partially prevents printing fluid residue from migrating across the air curtain, and therefore migrating toward the user 210a (as described with reference to FIG. 1b).

In each example apparatus 200a-c, the air curtain is created to at least partially prevent (or, in some examples, substantially eliminate) printing fluid reside from migrating toward the users 210a-c of the apparatus 200a-c. In each example, the flow of air 208a, 208b, 209b, 208c may be a laminar (e.g. not turbulent) flow of air in order to create the air curtain 212a, 212b, 213b, 212c.

Any one of the apparatus 100, 200a-c, shown respectively in FIGS. 1-2 may additionally comprise a sublimation station, or a heating station, comprising a heater to apply heat to the substrate to evaporate the liquid carrier from the printing fluid, leaving the printing fluid solids deposited on the substrate to form the image thereon. In some examples, the apparatus 100, 200a-c, may comprise a print platen on which the substrate is position during a print operation (e.g. during transfer of the printing fluid to the substrate). Accordingly, in some examples, the substrate may comprise a textile or fabric such as a garment. In some examples, the apparatus 100, 200a-c, may comprise a hand-held apparatus. In these examples, the apparatus 100, 200a-c, may comprise a handle and/or a button, the user-manipulation of which may actuate and/or control the discharge of printing fluid from the printing fluid device. In this example the operator of the apparatus may generally be positioned in front of the apparatus and holding the apparatus out in front of them to print to a substrate. In these examples, the substrate may also generally be positioned in front of the apparatus and so creating the air curtain in front of the apparatus, in between the substrate and the apparatus, and/or in between the substrate and the printing fluid device of the apparatus may at least partially prevent (or substantially eliminate) the migration of printing fluid residue from an area proximate the substrate to an area “behind” the apparatus where the user operating the apparatus may be located, thereby at least partially preventing the migration of printing fluid residue toward the user.

To effect printing to the substrate, the printing fluid devices 104, 204a-c, may comprise a printing cartridge and/or a printing fluid nozzle array and/or a printing fluid reservoir to supply printing fluid for discharge and the printing fluid devices 104, 204a-c, may be to control the selective discharge of printing fluid (e.g. through a nozzle array in the cartridge) toward the substrate according to image pattern data, which may in some examples be held in or communicated to the printing apparatus 100, 200a-c. For this purpose, the printing apparatus 100, 200a-c, may comprise a non-transitory processor- or computer-readable storage media and/or a memory, for example a read only memory (ROM), random access memory (RAM), and/or a data store (e.g. a solid-state storage media such as flash memory or hard disk), these components being to store image generation instructions, where the printing fluid device is to controllable discharge printing fluid toward the substrate according to the instructions. In some examples, the apparatus 100, 200a-c, may comprise a transmitter/receiver such as a Wi-Fi unit or Bluetooth that is to receive the image generation instructions.

In some examples, the air-flow device(s) as described above may comprise a heating device and/or heating element and/or a heater to heat the air, or a cooling device to cool the air. In these examples the air curtain may comprise a thermal air curtain. For example, the air curtain may define a region of higher (or lower) temperature than an adjacent region on another side of the air curtain. For example, the air curtain may define an interface between two regions of different temperature.

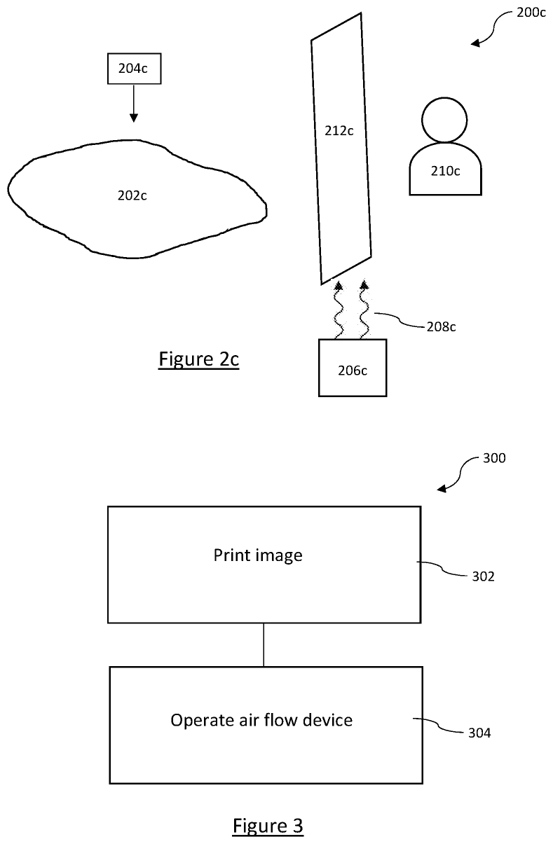

FIG. 3 shows an example method 300 which may comprise a computer-implemented method and which may comprise a method of controlling vapor emissions of a printing apparatus (for example a hand-held printing apparatus) for printing to a substrate (for example a garment). The method 300 may comprise a method of at least partially preventing printing fluid residue from reaching a user of a printing apparatus. The method 300 may comprise a method of operating a printing apparatus (for example the printing apparatus 100, 200a-c, as described above with reference to FIGS. 1 and 2 above).

At block 302, the method comprises printing image to a substrate, e.g. under the control of a controller or by a processor, e.g. of a printing apparatus. Block 302 may comprise operating a printing fluid device (such as those 104, 204 described with reference to FIGS. 1 and 2 above) to print an image to a substrate, for example according to image generation data which may be stored in, or transmitted to, a printing apparatus comprising the print fluid device. Block 302 may comprise causing an array of nozzles of a print fluid device to fire in sequence to print the image to the substrate. In some examples, block 302 may comprise applying heat to the substrate to at least partially evaporate the printing fluid liquid in the printing fluid, as part of a printing process to print the image to the substrate. Block 302 may therefore comprise at least partially sublimating the printing fluid.

At block 304, the method comprises operating an air flow device (such as the air flow devices 106, 206a, 206b, 207b, 206c described above with reference to FIGS. 1 and 2) to create an air curtain (such as those described above with reference to FIGS. 1 and 2) so that any printing fluid residue from the printing of the image to the substrate (e.g. at block 302) is at least partially prevented from migrating toward a user (e.g. of a printing apparatus for printing to the substrate).

Block 304 may comprise operating, e.g. under the control of a controller or by a processor, e.g. of a printing apparatus, an air flow device to create an air curtain in between the substrate and a printing fluid device for transferring printing fluid to a substrate to print an image onto the substrate. Block 304 may comprise operating an air flow device to create an air curtain in between a printing apparatus to print the image to the substrate and a user of the apparatus. Block 304 may comprise operating an air flow device to create an air curtain to substantially eliminate printing fluid residue in a region proximate the user. Block 304 may comprise operating an air flow to create an air curtain to define an interface between a region comprising printing fluid residue and a region comprising the user. In this way, one region may have a first air flow and a first air pressure and another region may have a second air flow and second air pressure and the air curtain may define an interface between the two regions. In this way, the air curtain may represent a barrier to at least partially prevent printing fluid residue from crossing, or migrating across, the air curtain. Block 304 may comprise operating an air flow device to create an air curtain to prevent printing fluid residue escaping a print area. Block 304 may comprise operating a fan or blower to move a volume of air to create the air curtain.

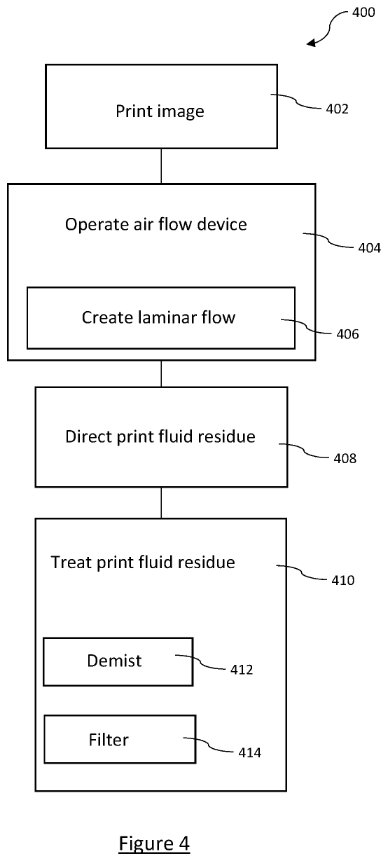

FIG. 4 shows an example method 400 which may comprise a computer-implemented method and which may comprise the method 300 as described above with reference to FIG. 3. The method 400 may be a method of controlling vapor emissions of a printing apparatus (for example a hand-held printing apparatus) for printing to a substrate (for example a garment). The method 400 may comprise a method of at least partially preventing printing fluid residue from reaching a user of a printing apparatus. The method 400 may comprise a method of operating a printing apparatus (for example the printing apparatus 100, 200a-c, as described above with reference to FIGS. 1 and 2 above).

At block 402, the method comprises printing image to a substrate, for example as described above with reference to block 302 of the method 300.

At block 404, the method comprises operating an air flow device, for example as described above with reference to block 304 of the method 300.

As shown in FIG. 4, block 404 comprises, at block 406, creating a laminar flow of air (for example, a non-turbulent flow of air) to create the air curtain. Block 406 may comprise operating a fan, or a blower, of a printing apparatus to create the laminar flow. As described above, the fan, or blower, may be operated to produce a laminar flow of air parallel to the substrate, perpendicular to the substrate, or otherwise oriented with respect to the substrate.

At block 408, the method comprises, e.g. under the control of a controller or by a processor, e.g. of a printing apparatus, directing printing fluid residue to a treatment station to treat the printing fluid residue. For example, the treatment station may comprise a demister and filter, as will be described with reference to blocks 412 and 414. Block 408 may comprise creating an air flow to direct the printing fluid residue to the treatment station. In some examples, the air flow to direct the printing fluid residue to the treatment station may be the laminar flow created at block 406. In other words, block 406 may be to create a laminar flow of air to create the air curtain and to direct the printing fluid residue to the treatment station. In some examples, the air flow to direct the printing fluid residue to the treatment station may be different to the laminar air flow. In these examples, block 408 may comprise operating a fan or blower to produce a flow of air to direct the printing fluid residue to the treatment station.

Block 410 comprises treating the printing fluid residue. As shown in FIG. 4, treating the printing fluid residue in this example comprises demisting, at block 412, the printing fluid residue and filtering, 414, the demisted printing fluid residue. More specifically, block 412 comprises removing any liquid present in the printing fluid residue and storing the liquid residue in the demister (e.g. for subsequent cleaning, treatment, or removal), Block 412 may comprise separating printing fluid residue into liquid and vapor components. Block 414 comprises passing the resulting vapor (the vapor resulting from the printing fluid residue once it has been demisted) through a filter to treat the vapor. Block 414 may comprise adsorbing, by the filter, volatile organic compounds present in the resultant vapor when it is passed through the filter.

The method 300 or the method 400 may comprise a method of operating a hand-held printing apparatus or device, the hand-held printing apparatus being to print the image to the substrate and comprising the air flow device. In these examples, the method may comprise moving, e.g. by a user, the printing apparatus across the substrate (e.g. a paper or textile such as a garment) and operating the printing apparatus to cause the image to be printed to the substrate.

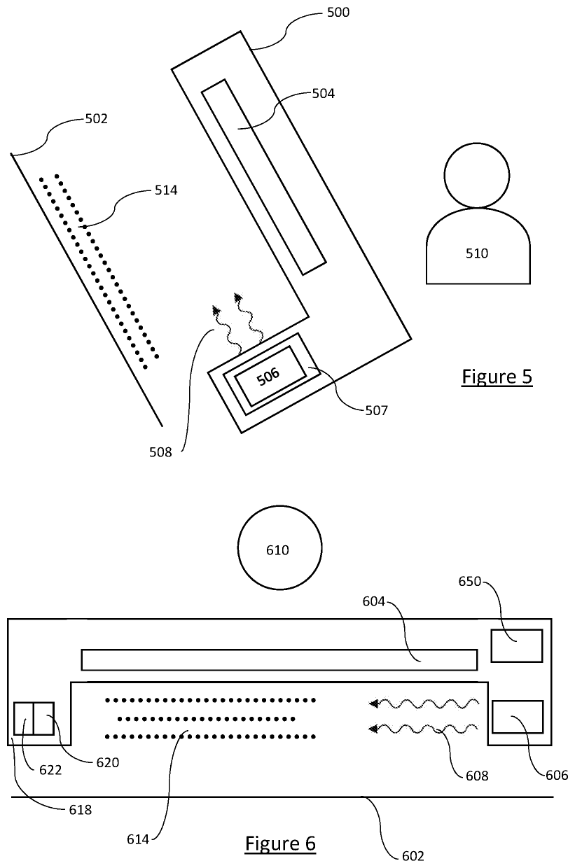

FIG. 5 shows an example printing apparatus 500. The printing apparatus 500 comprises a printing station 504 at which the printing apparatus 500 is to print an image onto a print media 502. The printing apparatus 500 comprises a vapor removal device 507 that comprises a fan 506. The fan 506 is to produce a laminar flow 508 of air such that any printing fluid vapors 514 generated from printing the image to the substrate 502 are at least partially prevented from travelling toward an operator 510 or a user) of the printing apparatus 500.

As shown in FIG. 5, the printing apparatus 500 may comprise a hand-held printing apparatus, e.g. one that is capable of being held by a user and intended to be operated by a user while being held. The printing apparatus 500 may therefore comprise a handle (not shown in FIG. 5) to be held by the user 510 to operate the printing apparatus 500. The laminar flow of air 508 created by the fan 506 may create an air flow curtain (e.g. as described above with reference to FIGS. 1-4). The printing station 504 of the printing apparatus 500 may comprise a heating device (for example may comprise a sublimation station) to apply heat to the print media 502, and may comprise a source of printing fluid such as a printhead or cartridge. Accordingly, the printing station 504 may comprise a recess to receive a printhead or cartridge. In examples where the printing apparatus 500 comprises a sublimation station, the vapor removal device may be located in the upper backside of the sublimation station.

FIG. 6 shows an example printing apparatus 600 which may comprise the apparatus 500 as shown in FIG. 5. The printing apparatus 600 of this example comprises a vapor treatment station 618 that is to reduce the quantity of liquid in the printing fluid vapor 614 and to reduce the concentration of VOCs in the printing fluid vapor 614. The vapor treatment station 618 in this example comprises a demister 620 and a filter 622. As described above with reference to block 410 of FIG. 4, the demister 620 is to remove any liquid present in the vapor 614 and the filter 614 is to treat the resultant (demisted) vapor to reduce the concentration of VOCs therein. The treatment station 618 may also be to store the vapor following filtration by the filter 622 or to release the treated vapor to the environment.

As shown in FIG. 6, the laminar flow of air 608 is to direct the vapor 614 toward the treatment station 618. Therefore, in this example the function of the laminar air flow 608 is two-fold; firstly, the laminar air flow 608 at least partially prevents the vapor 614 from travelling toward an operator 610 of the apparatus 600 and to direct the vapor 614 to be treated at the treatment station 618. The area proximate the substrate 602 and proximate the printing station 604 may be referred to as the “print area” of the printing apparatus 600 and the laminar flow of air 608 may be to prevent vapor 614 from migrating out of the print area and towards the operator 610.

The apparatus 600 of the FIG. 6 example may comprise a hand-held apparatus that the operator 610 may hold to print the image to the print media, which may comprise a garment. In this example, manipulation of the printing apparatus by the operator 610, e.g. by moving the apparatus by the user's hand across the substrate 602, may cause the image to be printed to the print media 602, in some examples with the manipulation of a control button on the apparatus 600.

The apparatus 600 of this example comprises a control unit 650. The control unit 650 may comprise a memory, such as ROM, RAM or flash memory to store machine-readable instructions which may comprise image generation instructions which describe the image to be printed to the substrate 602. The stored instructions may then be executed by the printing station 604 to cause the image described by the instructions to be printed onto the substrate 604 (e.g. to control the selective discharge of nozzles to cause the nozzles to direct printing fluid towards the print media to create the image thereon).

Some examples herein therefore relate to an apparatus, e.g. a hand-held apparatus, for printing to a substrate or print-media, e.g. a garment, having the capability of preventing unpleasant residue or vapors from printing fluid used to print to the substrate from being detected by a user of the apparatus.

Examples in the present disclosure can be provided as methods, systems or machine-readable instructions, such as any combination of software, hardware, firmware or the like. Such machine-readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. An apparatus for printing to a substrate, the apparatus comprising:
a printing fluid device for transferring printing fluid to a substrate; and
an air flow device to create an air curtain so that any printing fluid residue from the transfer of the printing fluid to the substrate is at least partially prevented from migrating toward a user of the apparatus.

2. An apparatus as claimed in claim 1, wherein the air flow device is to create the air curtain such that printing fluid residue is at least partially prevented from crossing the air curtain.

3. An apparatus as claimed in claim 1, wherein the air flow device is to create the air curtain such that the air curtain is parallel to the substrate.

4. An apparatus as claimed in claim 1, further comprising a demister to remove any liquid droplets from the printing fluid residue.

5. An apparatus as claimed in claim 4, further comprising a filter disposed downstream of the demister, the filter being to reduce the concentration of volatile organic compounds in any vapor following demisting of the printing fluid residue.

6. An apparatus as claimed in claim 1 wherein the substrate comprises a garment.

7. An apparatus as claimed in claim 1, wherein the apparatus comprises a hand-held apparatus.

8. A method comprising:
printing an image to a substrate;
operating an air flow device to create an air curtain so that any printing fluid residue from the printing of the image to the substrate is at least partially prevented from migrating toward a user.

9. A method as claimed in claim 8, wherein operating the air flow device to create the air curtain comprises operating the air flow device to create a laminar flow of air across the substrate;

10. A method as claimed in claim 8, further comprising:
directing printing fluid residue towards a treatment station to treat the printing fluid residue.

11. A method as claimed in claim 8, wherein the method comprises a method of operating a hand-held printing device, the hand-held printing device being to print the image to the substrate, the hand-held printing device comprising the air flow device.

12. A printing apparatus comprising:
a printing station at which the apparatus is to print image onto a print media; and
a vapor removal device comprising a fan to produce a laminar flow of air such that any printing fluid vapors generated from printing the image onto the print media are at least partially prevented from travelling toward an operator of the printing apparatus.

13. A printing apparatus as claimed in claim 12, wherein the print media comprises a garment.

14. A printing apparatus as claimed in claim 2, wherein the printing apparatus comprises a hand-held printing apparatus.

15. A printing apparatus as claimed in claim 12, further comprising a vapor treatment station to reduce the quantity of liquid in the printing fluid vapor and/or to reduce the concentration of volatile organic compounds in the printing fluid vapor.
